(19) United States
(12) Patent Application Publication
(10) Pub. No.: US 2025/0365334 A1
(43) Pub. Date: Nov. 27, 2025

(54) ADAPTIVE BITRATE (ABR) MANIFEST PACING

(71) Applicant: ARRIS Enterprises LLC, Horsham, PA (US)

(72) Inventors: Christopher S. PTACEK, Scappoose, OR (US); David A. ROMRELL, Meridian, ID (US); Yixiang ZENG, Beaverton, OR (US); George S. PINSON, Portland, OR (US)

(73) Assignee: ARRIS Enterprises LLC, Horsham, PA (US)

(21) Appl. No.: 19/216,581

(22) Filed: May 22, 2025

Related U.S. Application Data
(60) Provisional application No. 63/650,805, filed on May 22, 2024.

(51) Int. Cl. H04L 65/70; H04N 21/84

(52) U.S. Cl. CPC H04L 65/70; H04N 21/84

(57) ABSTRACT

Devices, systems, and methods for providing sequential manifests by which a client device may requests chunks of audiovisual content identified in the sequential manifests. The sequential manifests provided to the client device may be modified relative to an input manifest from an origin content provider, to modulate the rate at which the input manifest is updated.

### CROSS REFERENCE TO RELATED APPLICATIONS

This application claims the benefit of priority under 35 U.S.C. § 119 (e) to the filing date of provisional U.S. Patent Application No. 63/650,805 filed on May 22, 2024, the contents of which are incorporated herein in its entirety.

### BACKGROUND

The subject matter of this application generally relates to Adaptive Bit Rate (ABR) multimedia streaming systems and methods.

Streaming multimedia over wired and/or wireless networks has become ubiquitous, being readily accessible through the Internet or other network connections such as 4G, Bluetooth, etc. Because any given multimedia content stream may be requested by any one of a variety of devices, such as desktop computers, laptops, cell phones, tablets and so forth, each with its own display capabilities and over network bandwidth of varying quality, adaptive bit rate protocols have been established by which a particular multimedia device may receive streamed content at a quality appropriate for that device and its current network connection quality. For example, an ABR system may provide an on-demand movie to an HD television with a broadband connection to the Internet at 1080p/4300 kbps and 5.1 surround audio while simultaneously delivering the same movie at 480p/1050 kbps and stereo audio to a cell phone connected to the Internet over a 4G service. Alternately, that same cell phone could change from 480p quality to 240p quality, and back again, as bandwidth changes as, say, a user moves among wireless networks of disparate quality.

ABR content is typically packaged into a number of segments to be delivered/played sequentially by a multimedia player, where each segment is hosted at one or more unique Universal Resource Locators (URLs) and comprises a transport stream file with e.g., a .ts extension. The content provider then makes the presentation available by publishing one or more manifests. For example, in one common ABR standard (HTTP Live Streaming or HLS), a top-level master manifest may uniquely identify a set of available variant multimedia streams, each of a particular published quality including an overall stream bitrate and a set of codecs used for video and audio, such as AVC for MPEG 4 video and AAC for audio. Each of these multimedia streams is then given a separate media manifest, or playlist, that sequentially identifies the URLs of the segment files or “chunks” that contain the media presentation. Other ABR system, such as Dynamic Adaptive Streaming over HTTP (DASH) combines these two lists in a single manifest provided to a client device.

When a user selects a presentation for streaming to a device, that device first selects the media stream having a quality that best matches the capabilities of the device as well as the bandwidth available to the device at that time. Given that selection, a media manifest (playlist manifest) associated with that stream is used to sequentially retrieve and display the presentation segments using the URLs listed in the playlist. If conditions change, such that bandwidth drops below a level for acceptable playback of the content, the device can select a different media stream lower quality multimedia stream, access the media manifest associated with that quality, and continue the presentation using the URLs from that manifest.

Oftentimes viewers will pause presentation of content or perform other trick play operations such as reversing or fast-forwarding content, and this alters the timeline by which the streamed content is being viewed. This creates inefficiencies in the content provider's systems, which requires considerable processing of the content provided to a viewer, prior to the viewer watching that content; a viewer pausing content makes unnecessary processing that may not be needed at a particular point in time, while fast-forwarding content consumes more resources than usual.

What is desired therefore, are improved systems and methods for providing manifests to client devices that reduce such inefficiencies.

### BRIEF DESCRIPTION OF THE DRAWINGS

For a better understanding of the invention, and to show how the same may be carried into effect, reference will now be made, by way of example, to the accompanying drawings, in which:

FIG. 1 shows an exemplary architecture for implementing the embodiments described in the present disclosure.

FIG. 2 shows an exemplary embodiment of the present disclosure for altering the pacing of manifests provided to client devices.

FIG. 3 shows exemplary manners in which the pacing of manifests provided to client devices may be altered.

### DETAILED DESCRIPTION

The present application discloses novel systems and methods by which a manifest manipulator controls or alters the pacing by which manifests provide new content segments to client devices. To facilitate the presentation of the embodiments described in the present application, the following definitions may be useful.

Pace and/or pacing: With respect to the present specification and subsequent claims, the terms “pace” and/or “pacing” refer to the rate at which manifests are updated to provide new segments to client devices.

Delayed Manifest: A type of paced manifest where the manifest/publish timestamps are altered so that the client device's initial location or tune point shifts the playback pacing of segments.

Trimmed Manifest: a manifest in which newer media segments are held back in the timeline until a desired request location/pacing of the tail satisfies the desired bitrate.

Reduced manifest: a manifest in which both the live point and the tail are trimmed and the manifest skips forward from the head to adjust the start time or window of needless prior segments.

Stream Composition Metadata: a general term encompassing various mechanisms for describing the actions that client presentation software must take to produce a content experience as intended for the user. Examples of this kind of metadata include playlists and instructions to video players, such as are expressed in HTTP Live Streaming (HLS) as manifests (multimedia), and in Dynamic Adaptive Streaming over HTTP (DASH) as Media Presentation Descriptions (MPDs) (multimedia), or to audio book readers as Publication Manifests. This improves service for any collection of customizable playlists or instructions that can be used to create the user experience.

Head: The part of the manifest generally used to refer to the oldest or start of the manifest or stream composition metadata.

Tail: The part of the manifest generally used to refer to the newest or end of the manifest or stream composition metadata. It may also be referred to as the live edge.

Window: used to define the size of the manifest being presented, and is often represented in terms of time.

Origin source: a source content in CDN.

Stream: the rendering, by a player device starting on a specific manifest URL (playlist/MPD), of a continuous view of decoded media segments.

User Experience: The overall experience of playing an asset, which can include user seek interactions with distinct player streams starting at different offsets.

Trick play: a user-initiated action that alters the user experience (location or rate): pause/resume, skip-forward, fast-forward, skip-backward, rewind, or seek to offset from timer/scrubber bar.

Scrubber Bar: A presentation to a user of an overall timeline (duration, live edge, window) and track play location and/or trick play based on seek offsets or thumbnails/frames. The size if the scrubber bar may be correlated with the depth of the manifest.

VOD asset: Video on Demand asset, aka static/closed presentation. Playback tends to start at beginning of program and plays continuously to the end. VOD assets allow trick plays, but may limit them during marked ad breaks. For pre-bound advertisements, ad breaks are within the timeline and may appear as notated (e.g., colored) intervals on a scrubber bar. The player device plays them continuously. For late-bound advertisements, ad breaks are external to the timeline and may appear as a notated (e.g., colored) tick mark on a scrubber bar. The player device pauses, segues to the ad break, then returns.

Live asset or program: Also known as an “Event.” An event or program presented “live.” It is characterized by a fixed head at the program start time, and where the program tail grows while live media is recording. Live programs allow trick plays in timeline, but have a maximum duration or may switch to a live window.

Live Window: The client device “tunes” to a playback offset near live point with window of recent media. Characterized by indefinite playback. A Live Window with a Visible Timeline has a relatively longer buffer (e.g., 10-180 min) of recent timeline that allows pause/resume or other trick play within the timeline (scrubber). A “Live only” Live Window typically has a shorter manifest (e.g., 1 min) with the window used for network resiliency, and typically excludes user controls for any trick play.

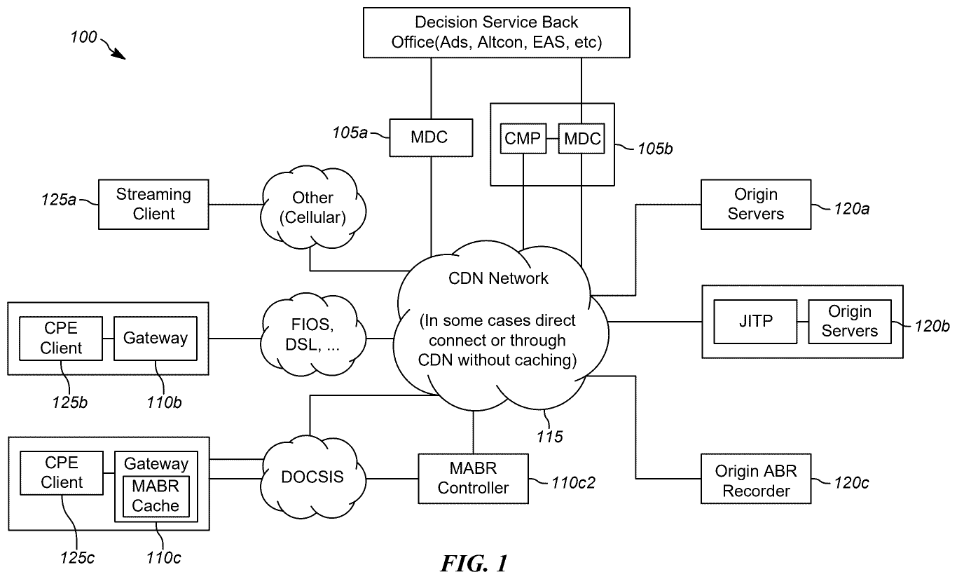

FIG. 1 shows an exemplary architecture 100 for delivering adaptive bitrate content from Origin servers 120a, 120b to client player devices 125am 125b, 125c using a content delivery network 115, such as the Internet. Specifically, content providers may operate Origin servers such as servers 120a, 120b, 120c to deliver audiovisual content to a wide variety of subscriber devices, such as a streaming client 125a connected to the Internet 115 via cellular network 100, a CPE client 125b such as a computer, laptop, etc. connected through a cable/DSL gateway 110b, or a television or other display 125c connected to a set top box 110c that propagates signals to and from the Internet 115 via a Data over Cable Services Interface Specification (DOCSIS) network.

As previously noted, adaptive bitrate (ABR) architectures such as HLS or DASH provide programs to client devices as sequential chunks of content, where each chunk of content can be accessed via a link (URL) provided to the client device in a playlist manifest. These manifests are created by devices called Manifest Manipulators, such as the MDCs (Manifest Delivery Controllers) 105a, 105b of FIG. 1. Origin servers such as server 120b provide their content to a just-in-time packager (JITP) which packages the sequential chunks and provides them to the MDC 105a, 105b, which then constructs/manipulates the manifest, optionally inserting advertisement content into the manifest. The sequential chunks of content are cached at locations accessed via URLS, and the manifest is created/published by MDCs such as MDC 105a 105b for access by the CPE clients 125a, 125b, 125c.

In prior art ABR architectures, manifests are manipulated or updated at a rate determined by a content packager (e.g., JITP) that packages new segments and provides them to the manifest manipulator. The manifest manipulator then updates the manifest based on this packager output rate and presents new content to client devices accordingly. The present invention, conversely, includes manifest manipulators (e.g., 105a, 105b) that control the pacing by which a manifest presents new content segments to client devices. This provides efficiency benefits to content providers, allowing conservation of resources such as CPU and memory consumption, as well as improved network bandwidth utilization. In some embodiments, the manifest manipulator defines a temporal window of content provided to each client device in reference to locations in the manifest, and allows the characteristics of the window, e.g., size of the window, the current playback position in the window, etc. to be changed based on feedback or information from the client device as it alters the play rate when pausing or seeking, for example. Thus, in such embodiments, the pacing of new content to a client device may change over the course of the playback of a content item.

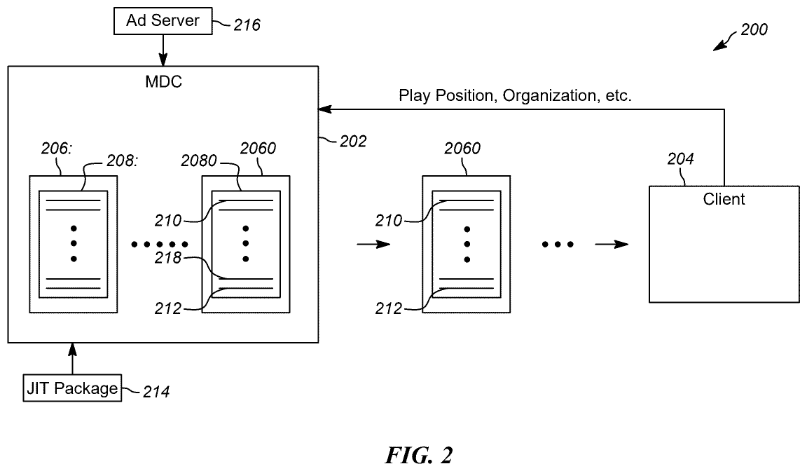

Referring to FIG. 2, a system 200 may include a manifest manipulator 202 (e.g., Manifest Delivery Controller) that receives from a packager 214 an sequential input manifests 206i (or constructs such input manifests 208i from packager input) and provides sequential output manifests 206o, to client device 204 so that client device 204 may access successive links to chunks of desired content. MDC 202 constructs manifests 206o that list these links or URLs, which define respective windows 208o, which are time intervals of the content respectively linked by the manifests 206o. In preferred embodiments, the size of the windows 208o may be variable, and determined by the MDC 202 based on feedback provided by the client 204, as described later. Each respective window 208o is defined by a head 210 and a tail 212.

The client device 204 may provide to the MDC 202 feedback relating to the manner in which it is presenting the content accessed via the manifests 208o that it has been provided. For example, the client device 204 may provide any or all of a current play position, a current operation (e.g., pause, fast forward, rewind, seek etc.), etc. The MDC 202 preferably uses that feedback to control the pacing of the manifests output to the client device 204. As one example, a variable size of the window 208o may be based upon feedback of the play rate of the client device. Thus, if a client device is fast forwarding content, or pausing content, etc., the MDC 202 may account for that in determining the temporal window 208o of the manifest 206o it is constructing for delivery to client device 204. Alternatively, or in addition, the MDC 202 may receive feedback of a current play position of the client device 204, and determine a tail segment 212 using that current play position and a previously determined size of the window 208o.

The pacing of the output manifests 206o is thus driven by configuring a window 208o defining what may be provided at any given point to the client device 204. The window 208o can in some embodiments be variable and change over time based on inputs to the system, including but not limited to feedback from the client device 204 such as the client's play rate, client's play position or any other general inputs that can shift the window view provided.

It should be understood that a novel characteristic of the system 200 is that the pacing of the input manifest 206i received from the packager 214, or constructed from input provided by the packager 214, differs from the pacing of the output manifest 206o. That is to say, the packager 214 may be providing updated input manifests 206i (or updates for input manifest 206i) to the MDC 202 at a first temporal rate, while the MDC 202 provides a sequence of output manifests to the client device 204 at a second rate different than the first rate. It should also be understood that another, independent novel characteristic of the system 200 is that the input manifest 206i and output manifest 206o, as previously defined, may have windows 208i, 208o respectively of different sizes, or alternately, have respective windows 208i, 208o sized independently of each other. It should also be understood that a third independent characteristic of the system 200 is that either or both of the pacing of the sequential output manifests 206o and window sizes of the output manifests 206o are determined by the MDC 202 based upon feedback from the client device 204.

The tail 212 (i.e., the newest portion of the output client window 208o) is preferably determined based on the desired output window size and the current client play position. When utilizing a client play position to drive the output manifest window the play position can be determined either by receiving direct feedback of a current play position or by calculating/estimating it based on such feedback using, e.g. a play rate and a time stamp. The window size then may be used to determine how much of the origin input manifest 206i to include ahead of the client positioning. The tail 212 of the output window 208o provided may be further limited by a configured maximum and minimum offset amount from the tail of the input manifest 208i, which could be limited by the output client window. If the calculated tail 212 of the output window 206o is determined to be further from the tail of the input manifest 206i than the maximum configured offset amount, then the maximum limit of the tail offset will in this embodiment be utilized to set the tail 212 of the output manifest 206a. If the calculated tail 212 of the window 208o of the output manifest 206o is determined to be closer to the tail of the input manifest 206i than the minimum limit of the tail offset amount then the minimum tail offset will be utilized in this embodiment to set the tail 212 of the output manifest 206o.

The tail position may in some embodiments also be adjusted gradually based on updates to the client play position or the client's playback rate. If, for example, a client device 204 pauses or seeks backwards to a point, the tail 212 may optionally be held in place or grown at a slower rate than the live edge or tail of the input manifest 206i in order to avoid removing portions of the window already provided to the client in prior updates. This may have the effect of growing the overall size of the window 208o for some period of time, but would then gradually return to a desired or configured size as the client device 204 continued to play and the client play position moved forward.

The head 208 or oldest portion of the output client window may be determined based on a desired output window size and the determined tail position of the output manifest 206o. With the tail 212 for the output manifest 206o previously determined, a desired window size can then be applied to calculate the head 210 of the output manifest 206o. If the head 210 extends past the head of the input origin manifest 206i, window 208o of the output manifest 206o could optionally be filled with cached segments from prior input manifest updates or be trimmed to stop at the same point as the head of the input manifest 206i. With a LIVE Program input manifest the window size can be set to a very large number that would greatly exceed the input manifest duration in order to limit the window based on the input manifest's fixed tail position.

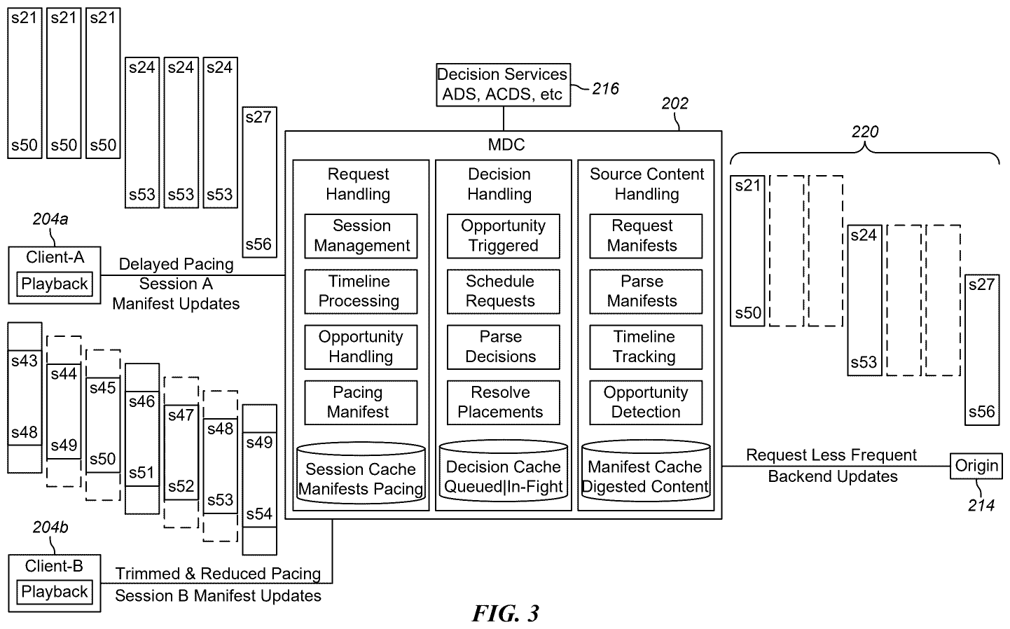

FIG. 3 shows exemplary embodiments of how the pacing of manifests provided to client devices may be altered. Specifically, FIG. 3 shows MDC 202 receiving backend updates from an origin packager 214, the backend updates comprising or used to create updated input manifests as described with respect to FIG. 2. The rate of these updates is shown as the sequence 220 of segment windows e.g., windows of segments 21-50, segments 24-53, and segments 27-56. The MDC 202 outputs respective sequences of manifests to two different client devices 204a and 204b.

Feedback from client device 204a indicates that the pacing of manifests provided to it may be delayed. This may result, for example, from the client device pausing content, rewinding content, etc. The delay of manifests to the client may be implemented by e.g., resending prior cached update, outputting a longer cache Time-to-live (TTL), or adjusting MUP so that client requests for manifests are less frequent. Feedback from client 204b, conversely, indicates that output manifests may be trimmed, again perhaps because the client device is pausing content, rewinding content, etc. such that it does not need manifests with very large windows. The client updates appear continuous; the output manifest is smaller but comes from longer window. In either circumstance, the session pacing to the clients 204a, 204b allows less frequent backend updates by reusing internally cached manifests.

The filling of opportunities for either Ad or Blackout insertions 218 can be performed based on either the input origin manifest or the altered output manifest timeline. Issuing decision requests when the opportunities are first seen in the input manifest allows those opportunities to be filled at a time that aligns closer to their actual appearance in the original manifest and can help to front load more of the workload for processing the opportunities. Issuing a decision requests when the opportunity approaches the output manifest window, though but may still not quite be within the output window, it allows a decision based on the current time the player is reaching the opportunity. This provides a mechanism to insert advertisements received from Ad server 216 that may be more aligned with the actual client play time as opposed to the timeline in the input origin manifest. This would also help to distribute the load in many cases over the play time of the content as with large or static content the opportunity processing would be distributed as based on the altered output window timeline.

Performance gains by utilizing the paced altered output window 208o can be significant. As the window 208o may not be following the live edge of the input manifest 206i, and is often a subsection of the window size of the input manifest 206i, the system of FIG. 2 permits efficient processing of the input manifest along with opportunities and merge functionality to be done at a frequency much lower than the client request rate. Once the input manifest 206i is processed and merged, the prior object can be reused to generate the next output window 208o provided to the client 204. The utilization of a previous merge action can continue to be utilized until there no longer remains enough information in the input or merged manifest state to fulfill the desired output window 208oi, or upcoming opportunities need to be detected at some given rate. This saves input processing resources, in many cases by orders of magnitude.

Network performance is also improved. By altering the output window 208o provided to the client 204 to be some smaller subsection of the window of the input manifest 206i, the relative size of the output manifest 206o provided to the client 204 is also smaller than the input manifest 206i. The ratio of the network bandwidth savings would be determined by the ratio of the input manifest window size to the output manifest window size. Memory improvements will also be realized, and as for tracking output manifest data and timeline, the size of the output manifest would be smaller to some degree. This would reduce memory consumption requirements on the portion needed to maintain output manifest state

The pacing of an alternate view of the output manifest 206o to the client 204 can be determined using any of a wide variety of techniques, based on the feedback from the client device 204, by selectively modifying placement of any or all of the head 210 or tail 212, of the output manifests 206o relative to the input manifest 206i. In some embodiments, the pacing of, and presentation of output manifests 206o to the client device 214 may be configurable by the client device. For example, the window 208a provided to the client can be defined largely by defining two points in the manifest, the head of the view and the tail of the view. The client's actual play position would then be some point in that window between the head and tail of the view provided. The client play position can be set by default values and adjusted by configuration or via direct client input through an interface that allows the client to define attributes related to the client's playing within the manifest. These updates can include relative offset position, absolute time position, play rates and other metrics that may be used to determine the current play position for driving the window provided.

Individual control points can be manipulated specifically and in any combination. An input LIVE Program with a fixed head and moving tail may have the manifests timeline adjusted as well as providing a moving head and a tail that is offset from the input tail to create a LIVE Window output with an offset manifest timeline. The combination of manifest type, timings and head/tail points however may be limited by the input manifest type. For example, an input manifest with a LIVE Window may not want to hold the head position of the output manifest fixed as the state would be lost over time. Even manipulating a single element can provide many possibilities in manifest control, such as:
A. LIVE Program delayed by time—Stream growing manifest shifted in time for both live point and start point (appear as joining live but all times appears as if program started late).
B. LIVE Program trimmed to time—Stream growing manifest trimming back on live point but retaining start point (start/seek times stay same but delay visibility of the live segment).
C. LIVE Program reduced by time—Stream growing manifest trimmed back on live point AND cut program start point (can limit start at a resume offset and delay visible live segments).
D. LIVE Window delayed by time—Stream live window shifted back in time for both live point and start window (as if it is being packaged late—may need higher CDN TTL for segments).
E. LIVE Window trimmed by time—Stream live window trimmed back on live point but still aligned to input start window (manifest a bit shorter, client joins/resumes behind live).
F. LIVE Window reduced by time—Stream live window trimmed back on live point AND cut at start of window (remote needless history in timeline, client joins/resumes behind live).
G. LIVE re-pacing from VOD—Stream live generated window at the initial play/seek with offset references for window start/end all forward paced for output media rate over time.
H. LIVE re-pacing from Program—Stream live generated window at the initial play/seek with offset references for window start/end all forward paced for output media rate over time.
I. LIVE re-pacing from LIVE Window—Stream live generated window at the initial tune offset with offset references for start/end and forward paced for output media rate over time.

The capabilities introduced by the ability to control the pace of the output manifest 206o stream may include several elements including any combination of one or more of the following:
Creating LIVE user experience by re-pacing other content i.e., a method to build or simulate a live stream without a Base Linear Stream Creator (BLSC)].
   Re-pacing from within a single static VOD, recorded content, or joining within a wider live window.
   Re-pacing as a single stream but sourced by multiple contiguous VOD, recorded content, or switch to wider live.
   Re-pacing as a single stream but with merged content from various source assets [VOD, alternate content, Emergency Alert System (EAS)].
   Still allows same benefits from above as it handles these various source contents.
Reducing visible asset and/or pacing to limit the available user experience:
   Policy to reduce asset such as starting manifest and re-pacing at a program boundary (param/marker/ADS/ESNI/etc). [ESNI is a protocol to describe program boundaries per SCTE 224].
   Policy to move a VOD or growing program to have live point nearer to play location (as if still active or delayed).
   Reduce available trick play period such as from the resume point or tune point forward within recorded content.
   Reduce available trick play to only within N seconds of current play location.
Enabling wider user experience across multiple re-pacing stream instances (application layer seek/resume each as distinct streams):
   Associate distinct stream instance URL in player to common user playback session ID by e.g., making a scrubber bar specific to particular content (e.g. sgrp/swn/?)
      Can combine with common Ibhdk for affinity to SAT with past context and session state (ad decisions).
      Allows diagnostics and reporting of overall user playback experience, status, control across streams.
   Enable retention of prior stream merges (ad decisions) for use in future stream for common content timeline.
      Or make this option and/or provide policy to rebind ads for secondary playback
      See above for doing late binding ad decision/insert with stream closer to play point.
Enabling wider user experience by providing scrubber/timeline that spans set of wider merged content or streams:
   Give digested view of modified upstream timelines for client/app to paint a wider timeline
      Start time, end time, or growing time, projected program end
      Marked points or periods within upstream timeline for ad insert, replace, and other events.
      Marked points that may form disjoint sections that may be shifted by late bind insert/delete.
   Provide thumbnails/iframes across the timeline based on past, ongoing, or planned merges:
      Option that shows underlying break thumbnails for periods yet to be replaced.
      Option for pre-bound adverts in timeline as they open scrubber bar
      Option for late-bound adverts simply marked in timeline but skipped/default for thumbnails.

The ability to pace and otherwise alter the clients view of the timeline within the stream composition metadata or manifest provides mechanisms for the conservation of resources such as CPU consumption, memory consumption as well as network bandwidth utilization. The impacts seen by implementations can be realized system wide. Some of the benefits seen from the manipulation and pacing are:
Reduced system costs by reducing ratio/frequency of processing source content (frontend 2 sec interval with backend 10 sec interval);
   Reduced load to backend content sources (Origin, CDN, network)
   Reduced processing of the source content (parsing and processing backend resources into digested objects).
   Reduced generation of output content (pre-merged what will be paced until the next update interval)
Reduced manifest output to only the essential timeline near the play point:
   Greatly reducing the manifest output size can reduce network bandwidth consumption to clients.
   Reduced processing/networking costs on the server and output generation.

The altered client's timeline also allows the system to react to inputs based on the client's currently altered timeline to provide real-time decisions that may further alter the manifest such as Ad or Blackout placements, as well as providing smoother manifest updates as seen by the client. Thus, the following benefits and/or features may be achieved.
Controlled smoothness of the progression for frontend pacing:
   Using pacing function to control the rate of progression of output across the update intervals i.e., smoothing out manifest updates.
   Options to adjust frontend caching/update interval per client for more stuttered/scattered frontend request processing from among multiple clients.
Manage ADS decisions to be nearer to time of the pacing and associated nearer play point:
   Allow campaigns to target closer to actual playback point (e.g. household browsing from client IP nearer to time of break).
   Avoid waste or ad decision/processing of an insert at location that player may never reach (especially if past or far future).
   Improve timeliness of the client tracker closer to the point of decision (more immediate monitoring of the ad execution).
Can increasing time between decision triggers/signals such as advertisement decisions and blackout decisions, and the need to output merged content:
   Increase/relaxed deadline in decisions and resolution before output is needed.
   Manage backend updates/monitoring to detect triggers earlier.
   Possibly allow out-of-band trigger to create pre-decisions at signal time (or earlier).
Staggering the reference pacing seen across many clients can limit the spikes seen by system resources while processing the merge of various placements.
   Separate the pacing start point/reference (or frequency/ratio) to reduce alignment,
   Alter the client timestamps (AST, Timestamps) to stagger the frontend update.
   Alter the update timing to stagger the internal and backend updates between channels.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A manifest manipulator operatively connected to a packager that packages sequential chunks of audiovisual content to be streamed, and to a client device configured to present the content streamed using a sequence of output manifests provided by the manifest manipulator, the manifest manipulator configured to:
process one or more input manifests for the audiovisual content, the one or more input manifests updated using data from the packager and updated at a first temporal rate;
the one or more input manifests processed to sequentially provide a plurality of output manifests paced to the client device at a second temporal rate independent from the first temporal rate.

2. The manifest manipulator of claim 1 where at least one of the first temporal rate and the second temporal rate is determined using feedback from the client device.

3. The manifest manipulator of claim 2 where the feedback includes a play position.

4. The manifest manipulator of claim 2 where the feedback is used to determine at least one of a chunk at the head of an output manifest and a chunk at a tail of the output manifest.

5. The manifest manipulator of claim 1 where the output manifest is at least one of delayed, trimmed or reduced relative to the input manifest.

6. A manifest manipulator operatively connected to a packager that packages sequential chunks of audiovisual content to be streamed, and to a client device configured to present the content streamed using a sequence of output manifests provided by the manifest manipulator, the manifest manipulator configured to:
update at least one input manifest for the audiovisual content using information received from the packager;
receive feedback from the client device related to the manner in which the audiovisual content is currently being presented; and
using the feedback and updated at least one input manifest to determine at least one parameter of the window of a next sequential output manifest provided to the client device.

7. The manifest manipulator of claim 6 where the next sequential output manifest is delayed relative to a current rate at which the input manifest is updated.

8. The manifest manipulator of claim 6 where the next sequential output manifest is trimmed relative to a currently updated input manifest.

9. The manifest manipulator of claim 6 where the feedback from the client device is used to determine at least one of a chunk at the head of an output manifest and a chunk at a tail of the output manifest.

10. The manifest manipulator of claim 6 where the feedback is used by the manifest manipulator to control the rate at which the input manifest is updated.

11. A method for manipulating an output manifest provided to a client device configured to present audiovisual content streamed as a sequence of content chunks using the output manifest, the method comprising:
receiving data from a packager defining a sequence of updated input manifests for the sequence of content chunks of the audiovisual content;
receive feedback from the client device related to the manner in which the audiovisual content is currently being presented; and
using the feedback and a currently updated one of the sequence of updated input manifests to determine at least one parameter of a window of a next sequential output manifest provided to the client device.

12. The method of claim 11 where a next sequential output manifest is delayed relative to a current rate at which the input manifest is updated.

13. The method of claim 11 where a next sequential output manifest is trimmed relative to a currently updated input manifest.

14. The method of claim 11 where the feedback from the client device is used to determine at least one of a chunk at the head of the output manifest and a chunk at a tail of the output manifest.

15. The method of claim 11 where the feedback is used by the manifest manipulator to control the rate at which the input manifest is updated.
